(19) United States
(12) Patent Application Publication
(10) Pub. No.: US 2025/0120553 A1
(43) Pub. Date: Apr. 17, 2025

(54) TOOL FOR FOOD PANS

(71) Applicant: Jeff Kirkland, Wildomar, CA (US)

(72) Inventor: Jeff Kirkland, Wildomar, CA (US)

(21) Appl. No.: 18/913,865

(22) Filed: Oct. 11, 2024

Related U.S. Application Data
(60) Provisional application No. 63/589,956, filed on Oct. 12, 2023.

(51) Int. Cl. A47J 45/10

(52) U.S. Cl. CPC A47J 45/10

(57) ABSTRACT

Provided herein is a tool configured to secure onto a corner of a food pan for catering, the tool having: a main body; a tongue, a first arm, a second arm, a front bent region, and a rear bent region; wherein the front bent region and the rear bent region are situated between the tongue and the main body; wherein a gap is provided between the front bent region and the rear bent region; and wherein the first arm and the second arm extend outwards from the main body at the front bent region and the rear bent region.

### CROSS-REFERENCE TO RELATED APPLICATIONS

This application claims the benefit of U.S. Provisional Application No. 63/589,956, filed Oct. 12, 2023, which is hereby incorporated by reference, to the extent that it is not conflicting with the present application.

### BACKGROUND OF INVENTION

### 1. Field of the Invention

The invention relates generally to restaurant industry tools, and more specifically to tools for handling catering equipment.

### 2. Description of the Related Art

Generally, chafing pans are frequently used for holding food during catering events and utilized for keeping food warm using indirect heat below the pan. These chafing pans may need to be changed during a catering event. This can be cumbersome and can result in injuries to a user's hands, fingers, and fingernails when grasping the chafing pan. Additionally, when serving sticky foods during catering events, such as mashed potatoes, rich, macaroni and cheese, and the like, serving utensils used for these foods often have residual food left after transferring food to a person's plate. These serving utensils are often scraped or banged on the chafing pans to remove the residual food from the spoon, which can cause damage, mess, or otherwise be disruptive to the event. Therefore, there is a need for a solution to these problems.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Provided herein are tools for securely holding and lifting food pans used in catering or serving scenarios. The tools provided herein may be referred to as a chafing pan holder, hotel pan holder, food pan holder, food pan tool, or pan holder. In some embodiments, the food pan tool may act as a removable holder on food pans that are not already provided with handles. Therefore, the food pan tool may help reduce risk of injury and also help to make the process of changing out pans during food service faster.

In some embodiments, the food pan tools provided herein may include a tongue that protrudes from the body of the tool. In such embodiments, the tongue can act as a scraper such that sticky foods can be easily and quickly scraped off of a serving utensil and back into the food pan.

In some embodiments, the food pan tools provided herein may include arms protruding from the body of the tool. In some embodiments, the food pan tools provided herein include two arms. In some embodiments, the food pan tools provided herein include two arms that protrude from the body of the tool, wherein each arm is angled at the same angle with respect to the axis of the tool body, with the body at the center and one arm on each side of the body. The orientation of the parts of the tools provided herein may help for the food pan tool to easily fit into a corner of a food pan.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 depicts a front, perspective view of a food pan tool, according to an aspect.

FIG. 2 depicts a rear, plan view of a food pan tool, according to an aspect.

FIG. 3 depicts a side elevation view of a food pan tool, according to an aspect.

FIG. 4 depicts a food pan tool 100 held against a corner of a food pan, according to an aspect.

FIG. 5 depicts a top view of a food pan tool secured onto a corner of a food pan, according to an aspect.

FIG. 6 depicts a side perspective view of a food pan tool secured onto a corner of a food pan 201, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

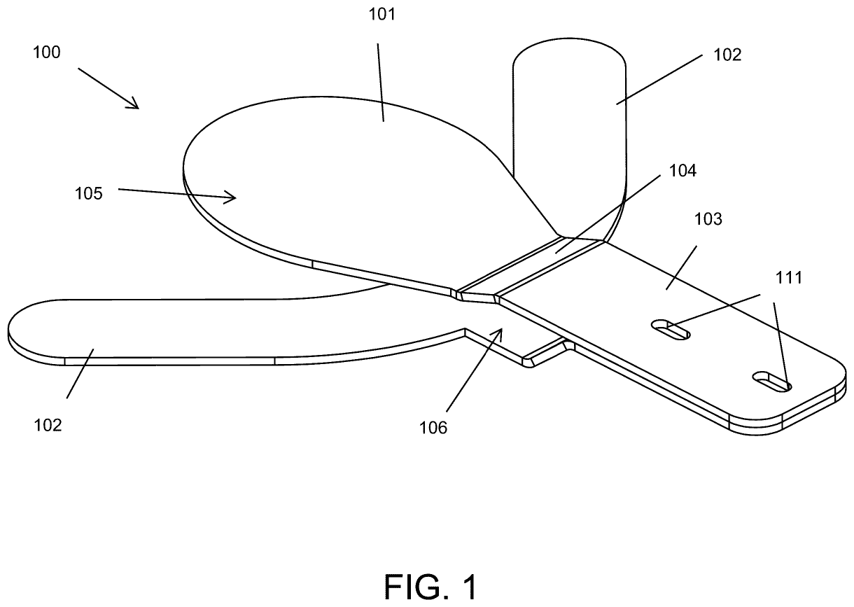

FIG. 1 depicts a front, perspective view of a food pan tool 100, according to an aspect. In some embodiments, the food pan tools provided herein include arms 102, a main body 103, a tongue 101, and a bent region 104 between the body 103 and the tongue 101. In some embodiments, the bent region 104 is oriented such that the tongue 101 is raised above the body 103 when the tool is lying flat. In some embodiments, the bent region 104 is oriented such that the tongue 101 is lower than the body 103 when the tool is lying flat. In some embodiments, each arm 102 extends outwards from the longitudinal axis of the body 103, and point substantially towards the tongue 101. In some embodiments, each arm 102 is provided at approximately a 45° angle with respect to the longitudinal axis of the body 103.

The tool 100 may also comprise holes 111 in the main body. In some embodiment, the tool is provided with two holes 111.

The tongue 101 and the arms 102 may each be provided with rounded ends. These rounded ends may contribute to safety as the rounded edges can reduce injury or accidental cuts. Additionally, the tongue and each of the arms may each comprise a flat top surface and a flat bottom surface.

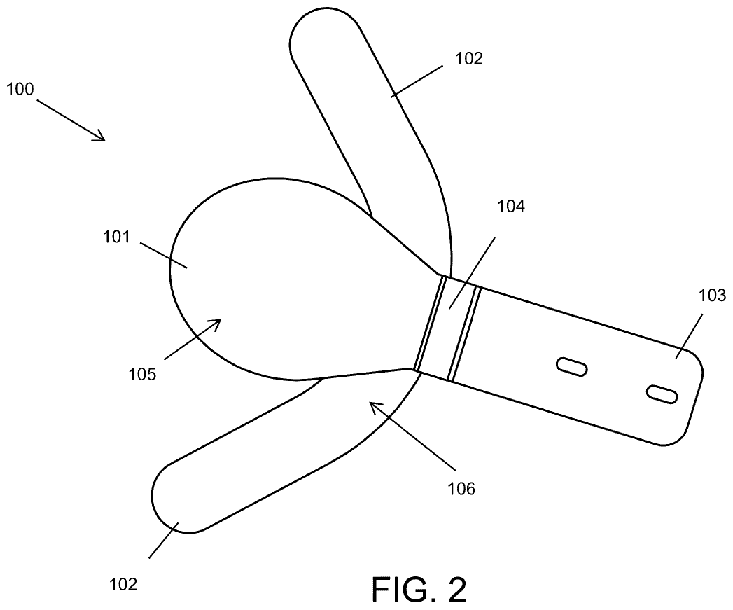

FIG. 2 depicts a rear, plan view of a food pan tool 100, according to an aspect. In some embodiments, the food pan tool 100 is made up of a first piece (also referred to herein as a “front piece”) 105 and a second piece (also referred to herein as a “rear piece”) 106. The front piece 105 comprises the front portion of the body 103 and the tongue 101. The rear piece 106 comprises the rear portion of the body 103 and the arms 102. Therefore, a main body 103 is made up of a portion of the front piece and a portion of the rear piece held together. In some embodiments, the front piece 105 and the rear piece 106 are integrated together by welding, fastening with any suitable securing means, or any suitable method of joining these pieces together. In some embodiments, the front piece 105 and the rear piece 106 are each provided with a bent region 104.

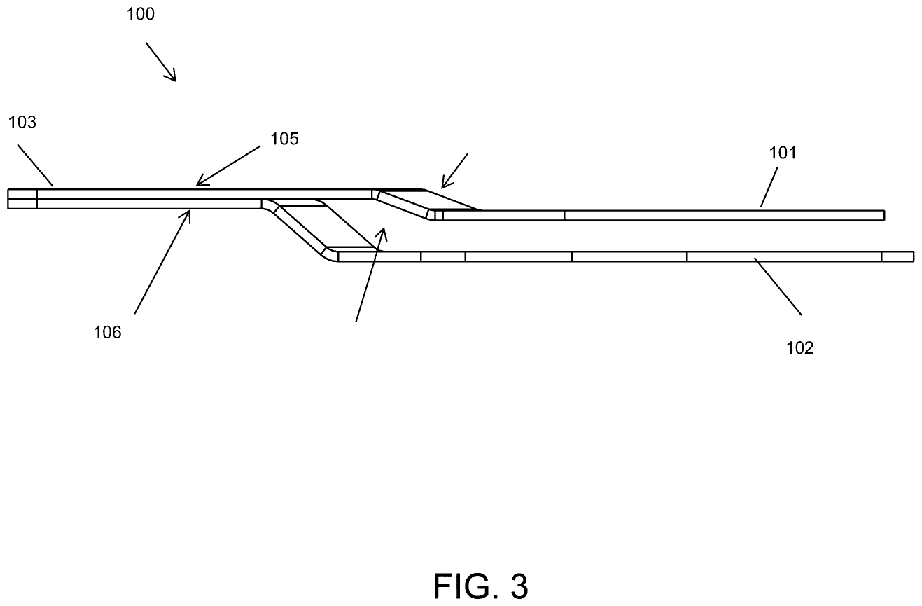

FIG. 3 depicts a side elevation view of a food pan tool 100, according to an aspect. The side view shows the front piece 105 oriented on top of the rear piece 106. At the body 103, the front piece 105 may be rested on top of the rear piece 106, while the tongue 101 is elevated above the arms 102. The gap 107 between the front piece 105 and the rear piece 106 where the tongue 101 and arms 102 are provided is created by the angles of the bent region 104. It should be understood that, in the view shown in FIG. 3, only one arm 102 is visible, but that the view of the opposite side elevation view is similar to that of FIG. 3.

As discussed above, the two pieces may be integrated together in any suitable manner, such as welding, screwing together with a securing means, and so on. It should also be understood that the food pan tools provided herein may also be provided a single integral piece with no need to secure separate pieces together. As also discussed above, in some embodiments, the front piece 105 and the rear piece 106 are each provided with a bent region 104. In such embodiments, the bent region 104 may be oriented such that the front piece and the rear piece are provided with the gap 107 between the pieces.

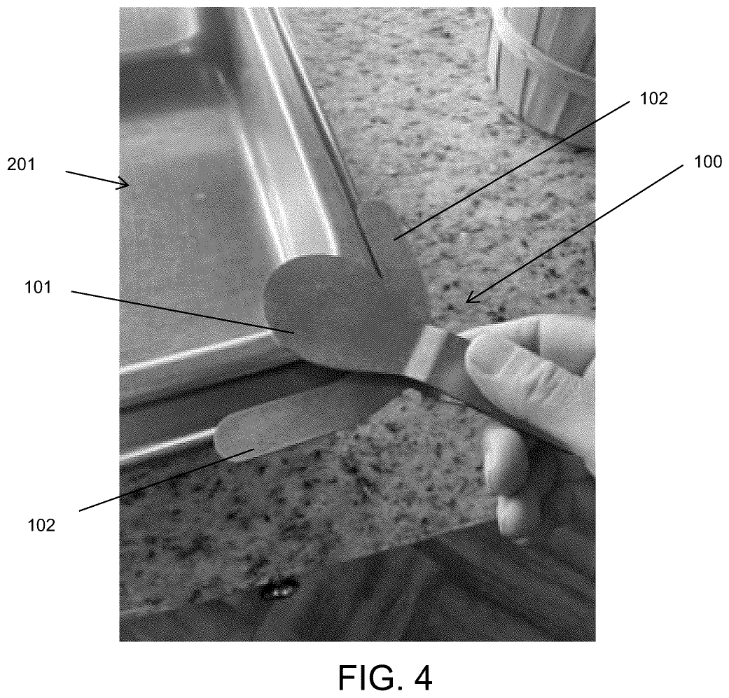

As shown, the gap 107 between the front piece 105 and the rear piece 106 may fully extend throughout the region between the tongue 101 and the arms 102. This gap 107 will allow the tool to grip onto the corner of a food pan. Generally, the gap 107 allows the food pan tool to snap into place when inserted onto a corner of a food pan, as will be described in more detail when referring to at least FIG. 4.

FIG. 4 depicts a food pan tool 100 held against a corner of a food pan 201, according to an aspect. The arms 102 of the food pan tool 100 are provided such that they lay along the sides of the right angle corner of the food pan 201, while the tongue 101 sits on top of the lip of the food pan.

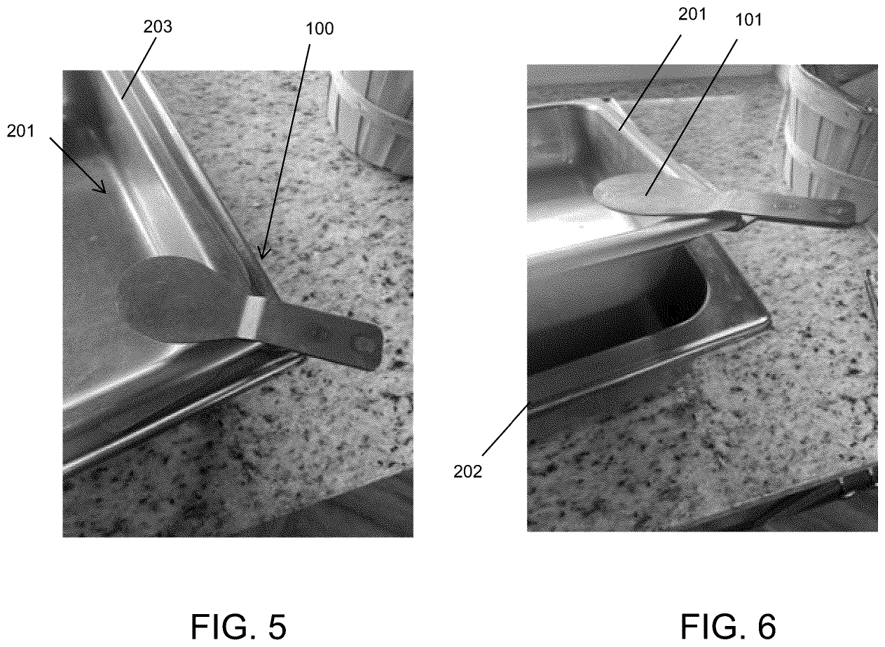

FIG. 5 depicts a top view of a food pan tool 100 secured onto a corner of a food pan 201, according to an aspect. When a food pan tool 100 is securely inserted onto a corner of a food pan 201, the arms of the food pan tool may be inserted underneath the lip 203 of the food pan, which generally runs along the top outer perimeter of the food pan 201. Then, the arms of the food pan tool would generally not be visible when the setup is viewed from the top (also referred to as the front view of the food pan tool 100). Generally, the size of the gap (shown as 107 in FIG. 3) may be provided such that the food pan tool can be securely placed on the food pan corners and stay secured, and can still be easily removed by a user by pulling the tool away from the pan without manipulation of any of the tool parts. In other words, the tool is not provided with moving parts but is provided with a suitably sized gap for securing onto the lip of a food pan.

FIG. 6 depicts a side perspective view of a food pan tool 100 secured onto a corner of a food pan 201, according to an aspect. Generally, food pans 201, also referred to as hotel pans, may rest in a second pan 202, which can be a water bath, referred to herein as a water pan 202. The water pan 202 may then be situated above a heat source in order to provide indirect heat to the food pan or hotel pan 201. In order to lift the hotel pan 201 out of the water pan 202, the food pan tool 100 may be secured onto a corner of the hotel pan 201. In some embodiments, two food pan tools 100 may be used, and may be secured onto two corners of the hotel pan 201, such as opposite corners. In some embodiments, corners across or kitty-corner or catty-corner from each other may be grasped using the food pan tools 100 provided herein. The user can then grasp the body of the food pan tool and easily and quickly lift the hotel pan 201 out of the water pan 202 in order to insert a new food pan tool into the water pan 202. When the new hotel pan 201 is inserted into the water pan 202 using the food pan tools, the food pan tools may be left secured onto the pan corners such that, during food or catering service, the tongue 101 of the food pan tool can be used as a food scraper.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A tool configured to secure onto a corner of a food pan for catering, the tool comprising:
a front piece having a front body, a tongue, and a front bent region between the front body and the tongue;
a rear piece having a rear body, a first arm, a second arm, and a rear bent region between the rear body and the first arm and the second arm;
wherein the front piece and the rear piece are connected together at the front body and the rear body to form a main body;
wherein the tongue and the front bent region are disconnected from the rear bent region, the first arm, and the second arm, such that a gap is provided between the front bent region and the rear bent region;
wherein the first arm is positioned on a left side of the body and angled outwards with respect to a longitudinal axis of the main body, and the second arm is positioned on a right side of the body and angled outwards with respect to the longitudinal axis of the body; and
wherein the first arm and the second arm are each angled with respect to the longitudinal axis of the main body at the same angle, such that the first arm rests against a first side of the food pan and the second arm rests against a second side of the food pan when the tool is secured onto the corner of the food pan, wherein the first side and the second side are adjacent to each other.

2. The tool of claim 1, wherein the first arm and the second arm are configured to be secured underneath a lip of the food pan and the tongue is configured to be secured above the lip of the food pan, and wherein the tool can be securely held on the corner of the food pan without moving components of the tool.

3. The tool of claim 1, wherein the first arm and the second arm are angled outwards with respect to the longitudinal axis of the body at approximately 45° degrees.

4. The tool of claim 1, where the main body comprises a plurality of holes.

5. The tool of claim 4, wherein the plurality of holes comprises two holes.

6. The tool of claim 1, wherein the tongue, the first arm, and the second arm each comprise rounded ends.

7. The tool of claim 1, wherein the front piece and the rear piece are connected together at the main body by welding.

8. The tool of claim 1, wherein the tongue, the first arm, and the second arm each comprise a flat top surface and a flat bottom surface.

9. A tool configured to secure onto a corner of a food pan for catering, the tool comprising:
a main body; a tongue, a first arm, a second arm, a front bent region, and a rear bent region;
wherein the front bent region and the rear bent region are situated between the tongue and the main body;
wherein a gap is provided between the front bent region and the rear bent region; and
wherein the first arm and the second arm extend outwards from the main body at the front bent region and the rear bent region.

10. The tool of claim 9, wherein the first arm and the second arm are configured to be secured underneath a lip of the food pan and the tongue is configured to be secured above the lip of the food pan, and wherein the tool can be securely held on the corner of the food pan without moving components of the tool.

11. The tool of claim 9, wherein the first arm and the second arm are angled outwards with respect to the longitudinal axis of the body at approximately 45° degrees.

12. The tool of claim 9, where the main body comprises a plurality of holes.

13. The tool of claim 12, wherein the plurality of holes comprises two holes.

14. The tool of claim 9, wherein the tongue, the first arm, and the second arm each comprise a flat top surface and a flat bottom surface.

15. A method of handling a food pan, comprising providing a tool comprising:
a main body; a tongue, a first arm, a second arm, a front bent region, and a rear bent region;
wherein the front bent region and the rear bent region are situated between the tongue and the main body;
wherein a gap is provided between the front bent region and the rear bent region; and
wherein the first arm and the second arm extend outwards from the main body at the front bent region and the rear bent region.

16. The method of claim 15, comprising securing the tool to a corner of the food pan, such that the first arm and the second arm are secured underneath a lip of the food pan and the tongue is secured above the lip of the food pan. wherein the tool can be securely held on the corner of the food pan without moving components of the tool.

17. The method of claim 15, wherein the first arm and the second arm are angled outwards with respect to the longitudinal axis of the body at approximately 45° degrees.

18. The method of claim 15, where the main body comprises a plurality of holes.

19. The method of claim 15, wherein the tongue, the first arm, and the second arm each comprise a flat top surface and a flat bottom surface.

20. The method of claim 15, wherein the tongue, the first arm, and the second arm each comprise rounded ends.
